(19) United States
(12) Patent Application Publication
(10) Pub. No.: US 2024/0100559 A1
(43) Pub. Date: Mar. 28, 2024

(54) APPLICATION NOZZLE WITH AN ELASTIC MOLDING REGION FOR MANUALLY APPLYING A DIMENSIONED PASTY SEALANT STRAND FOR A CORNER JOINT SEAL

(71) Applicant: Bernd KOWALESKI, Dohnsen (AT)

(72) Inventor: Bernd KOWALEWSKI, DOHNSEN (DE)

(21) Appl. No.: 18/264,864

(22) PCT Filed: Feb. 1, 2022
(86) PCT No.: PCT/DE2022/100089

§ 371 Date: Aug. 9, 2023

(30) Foreign Application Priority Data
Feb. 11, 2021 (DE) 10 2021 000 704.2

(51) Int. Cl. B05C 17/005

(52) U.S. Cl. CPC B05C 17/0052; B05C 17/00516

(57) ABSTRACT

The invention relates to an application nozzle (5.) for plastic sealants in a pasty form which can be easily and uniformly guided. The functional principle of the invention relates to a molding region (14.) made of an elastic structured rubber (8.) which is positioned by a guiding system, flexibly adapts to the adhesive surfaces, and has a pressure point-developing effect as a result of the molding region (14.) being sealed laterally or to the front (in the guide direction). By means of the pressure resistance, which changes noticeably to the user, in the counter-pressure of the hand lever during a manual application process using a conventional application pistol, the actuation of the hand lever becomes a simple control variable, from which a flawless visible surface results in a work process which is easy to control. The sealant material can be applied horizontally and vertically, as well as in an overhead position, in an approximately loss-free manner. The guiding system of the application nozzle (5.) consists of two contact bodies ((16.) and (21.)). By virtue of the dual function of the second contact body (21.), a central sealant abutment can be produced.

Plastic sealant pastes, which are also known as “assembly or construction silicones”, have different applications in the automobile, aviation and construction industries as well as in many other fields of technology and everyday life. These sealing materials used as process materials are usually moisture-curing polyaddition sealants which polymerize through air moisture. In terms of viscosity, friction properties in the material feed, the adhesion properties and plastic stability, these are designed to ensure that they can be applied to/inserted into the area to be sealed via an application nozzle under pressure. After the—usually manual—sealant application, these materials quickly adhere to the application substrate.

After application, the assembly or construction silicones adhere to the adjacent surfaces of the materials to be sealed with each other and then cure, with the materials remaining more or less permanently elastic depending on the silicone selected.

The following consideration is preceded by the note that the assembly or construction silicones are suitable for sealing of joints which usually have a joint width of approx. 3 to 25 mm. In this context, the angle of the surfaces between which a seal is to be created is not important. With regard to the application nozzle as per the invention, reference is made to sealing surfaces at right angles to each other under consideration of the usual tolerances in construction. The term usually used for this is “corner joint” (1). Here, a sealant bead having a triangular cross-section (2), which requires corresponding adhesion surfaces (3) in line with the material consistency on both surfaces to be sealed with each other, is created. The terms “leg” and “hypotenuse” are known from mathematical geometry. Using these terms, the legs form the adhesion surfaces (3), while the hypotenuse forms the future face (4) within the cross-section triangle. In some applications, the face (4) can have a kind of inward curvature in the form of a fillet. In most cases, isosceles, right-angled triangular cross-sections which should largely be constant with regard to the joint length are used for the sealant bead (2). An even face (4) which has a smooth surface and bridges the gap at a 45° angle (if applicable in the form of a fillet) is desired.

Moreover, the consideration is based on the precondition that the adhesion surfaces (3) are closed to such a degree that the sealant application creates the final sealant bead (2) with the face (4).

In practice, tapered plastic nozzles, which are screwed onto a round material feed opening within an external thread, are commonly used as standard nozzles for the single-strand material application. Because of the thin walls or the use of a soft plastic material, the opening in these nozzles can easily be adjusted to requirements by cutting them manually using a sharp blade. They are usually only single use (single-use nozzle) and, therefore, flexible in use.

Cutting the above-mentioned single-use nozzle to the desired width of the future face (4) is expedient. Usually, the user opts for a sloping cut which results in an ellipsoid opening of the nozzle tip. In terms of the joint or guiding direction, the nozzle then has to be held along the slanted cutting angle in as far as this is manually possible. Moreover, so-called supporting-ring nozzles are also known. These have circumferential grooves or notches which are helpful as cutting guides.

Under the commonly employed approach, the user guides the cut plastic nozzle so as to ensure that the edges which are opposite the cut opening of the plastic nozzle and which connect the minor axis of the ellipsis lie on the adhesion surfaces (3). The sealant paste is pressed through the nozzle as uniformly as possible in which process the nozzle is moved at an adequate guiding speed so that the desired triangular cross-section is filled with the sealant. As a result of the discharge pressure, the sealant first forms the adhesive contact, while almost simultaneously the face (4) of the sealing joint is shaped by the edge of the discharge opening opposite the guiding direction so as to ensure the smoothest possible appearance. However, a high level of manual dexterity is required to guide the nozzle in the manner described. Often, the edges of the nozzle do not touch the surface resulting in the sealing paste being discharged laterally, i.e., next to the desired bead. This, in turn, results in the need to remove the excessive sealant on the sides, which is tedious and very time-consuming.

Moreover, if the nozzle is tilted, the face (4) of the sealant bead (2) in the corner joint (1) is no longer even or the legs (as per the definition provided above) might not be constant along the length of the sealant bead. This results in a relatively unappealing bead along the length of the joint which can appear curvy.

So-called “joint smoothers” or “silicone remover tools” are commercially available. These are application tools with which the user can work on the material bead after the application of the sealant. To this end, the tools have corresponding shaping edges with which the contour of the sealant bead (2) can be molded. This means the freshly applied material which has not yet cured can be scraped off to achieve the desired look of the joint. During reworking, this tool pushes a relatively small quantity of the material to be shaped in front of the tool and distributes it evenly or shapes it into the face (4). In practice, however, this is only possible to a limited degree because excess material can accumulate to the side of the actual material bead which is then relatively difficult to remove. Or an insufficient amount of material was applied, in which case scraping off is only possible by creating a narrower—and, hence, undesired—face (4). Overall, this shaping method also requires a relatively high level of manual dexterity, and the application process definitely requires two working steps (1. application of the sealant and 2. scraping of the surface).

The simple smoothing of the face (4) of the sealant bead (2) by manual molding (i.e., using a finger instead of a tool) forms yet another possibility of reshaping. To this end, a separating agent is typically used to prevent adhesive contact. In this case again, the face (4) can only be changed to a small degree. As a rule, fundamental corrections regarding the desired shape of the joint are not possible. In addition, this type of reworking also has all of the disadvantages which were discussed for the above-mentioned joint smoothers/remover tools.

Moreover, devices which are inserted into the plastic nozzle described above are also commonly used. These devices are similar in design to a “joint smoother”; however, the sealant material (silicone paste) is expressed from the inserted nozzle in front of the smoother. This area is open to the application side, which permits a certain buffering of the material to be applied. The sealing material which accumulates there is pushed towards the corner joint (1) by the edges of the smoother which can be equipped with sealing lips for improved mechanical effectiveness and the material is then shaped into the desired bead by a covered shaping area designed as a notch at the tip of the smoother.

In general, this application system entails the disadvantage that a large part of the material first has to be pushed into the application area by the edges of the smoother. Any leaks during this open material transport result in misapplications which are relatively difficult to rework. Similar misapplications are caused by the user tilting the smoother during the application as a result of which the edge of the smoother is lifted off the surface. This leads to the formation of lateral smears. Moreover, as a result of the material buffering, a sufficient amount of silicone is always expressed in front of the smoother. Therefore, the bead might be torn when using the tool.

The “tool for processing of adhesives or sealants” (see DE 0000 196 46 352 A1) provides a known device into which a commercially available plastic tip has to be inserted and in which the sealing material is fed towards the corner joint (1) via a spherical joint. The lateral guiding surfaces help to hold the device in the longitudinal direction during the application of the material. But as this solution does not include any sealing components, it leads to lateral misapplications which are difficult to remove.

Furthermore, an application nozzle (patent application ref. no. 10 2020 005 094.8) the application opening of which is enclosed by sealing lips on the sides is known. This nozzle has two contact bodies which permit continuing guiding of the application area. In this system, the sealant material is directly introduced into the joint area and smoothed down by a shaping edge. At the same time, a buffer area forms in front of the shaping edge; this buffer compensates minor fluctuations in the continuity of the material feed and/or the relatively constant proportion between material feed and guiding speed which is required for the even application. However, this system also requires a certain level of practice on the part of the operator because the shaping pressure necessary in front of the shaping edge is only achieved based on the guiding speed provided there is a sufficient volume of sealant in the buffering area at the same time. One can start in the corner of the room when producing a sealant bead (2) using this nozzle; however, because of the drawing mode of operation, one cannot work into the corner of a room. This necessarily results in the formation of a sealant bead joint in the central area of the application bead.

However, this cannot be consistently shaped using this nozzle.

The state of the art also includes a “device for the application, delimitation and smoothing of joints manually filled in using a plastic filling compound” (see DE 20 2012 104 784 U1). This is characterized by the fact that the sliding surfaces of a prism-shaped sliding body which are approximately rectangular ensure that a rigid shaping bottom is guided parallel to the corner joint (1). This shaping bottom is guided into the corner of the room in a slanted position (position of the hypotenuse, according to a definition specified herein above) and has parallel sealing surfaces in the shape of sealing lips with a constant distance on the edge to delimit the sealing bead (2) to be shaped. The application area of the device is open towards the front (in the guiding direction) and back. A commercially available plastic nozzle is inserted into a conical feed opening which ends in a ball joint element and the sealant paste is provided via this. This paste collects between the corner area (legs, according to the definition provided above) and the rigid shaping bottom. At the same time, the sliding body is guided by the operator in the longitudinal direction (guiding direction) to the corner joint (1). The shaping bottom is kinked at the end and leads into the shaping area which has a curvature. This reduction in the cross-section leads to a certain local overpressure within the sealant material. A relief opening is designed for this, the constructive geometry of which controls the appropriate application pressure. This means that sealant material escapes via this release opening in the rear segment between the shaping bottom and the joint walls (legs). This leaves a sealant bead with the appropriate volume of sealant material and an even face and/or smooth surface. The excessive sealant material is collected in a type of collection area which has to be emptied periodically. The sealant material so removed is usually not re-usable and has to be disposed of.

In this application system, a vertical sealant bead can only be executed to a limited degree because the material escaping through the relief opening does not fully gather in the collecting area which is open in the direction of the outflow. The same also applies to ceiling connection joints, which might have to be installed overhead. Ultimately, any material that is discharged via the relief opening into the collection area which has to be emptied constitutes waste and reduces the profitability of the material input. The distance between the parallel sealing surfaces (in the shape of sealing lips) is constant, which means that the rigid shaping bottom can only adjust to irregularities in the application surface to a limited degree.

To smooth out the sealant bead, one end of the device has a smoothing surface which is slightly bent downwards and/or a rounded-off smoothing surface. However, the side edges of the smoothing surface are not sealed towards the application surface by sealing lips, as a result of which leaks onto the application substrate are possible in this area subject to pressure. This results in smears. A solution for the central sealant bead joint is not offered.

This results in the need for the creation of an application nozzle which places only low demands on the user's craft skills. With regard to products commonly available at DIY markets, it would be very advantageous to offer a system with which even inexperienced users/operators could produce a smooth sealant bead (2) in order to achieve the most flexible and easy-to-use application possible.

The aim was to achieve the production of a sealant bead (2) in one step without lateral smears both vertically and overhead. In this, the width of the face (4) is to be adjusted by molding to the application substrate (29) to compensate for the usual tolerances in construction. The need for reworking using a smoothing tool along the length of the sealant bead is to be avoided and the same also applies to the reduction in profitability caused by the waste of sealant. Moreover, the option for forming a central sealant bead joint is also part of the scope.

This is resolved by the application nozzle as per the invention (5). As in the case of the usual plastic nozzles, this nozzle is also screwed onto a round material feed opening with an external thread.

In the execution example, a total nozzle length of 95 mm was selected. The nozzle body (6) can be made of a relatively soft plastic as in the case of the commonly used standard nozzle described above.

The operating principle of the nozzle as per the invention is based on a shaping segment (14) made of elastic structured rubber (8), which is positioned by a guide system that flexibly adjusts to the adhesion surfaces (3) and has the effect of developing a pressure point because the application area (15) is sealed off to the side and front (in the guiding direction (12)).

To this end, the shaping area (14) of the nozzle head (7) is made of elastic, rectangular structured rubber (8), which, in terms of their consistency, is comparable to the bouncy rubbers mats commonly used in sports facilities. Internally, the material has a bubble or honeycomb structure. Similar rubber materials are also used to cushion mechanical strains. In the execution example, a structured rubber with a width of 13 mm was selected. To establish a connection to the nozzle body (6), the structured rubber (8) is glued into a fixture (13) on the nozzle head (7). This glued connection is so strong that it also seals the feed opening (18) through the structured rubber in the transition from the fixture (13) to the structured rubber (8). In commercial production, other constructive solutions, such as, e.g., direct thermoplastic welding to a correspondingly braced area on the nozzle head (7) is also conceivable. The surface (9) of the structured rubber (8) pointing to the application area (15) has a smooth execution to shape the face (4). In the execution example, a structured rubber which is equipped with a unilaterally reinforced surface (9) during production and a correspondingly smooth surface (9) was selected. The reinforcement is comparable to a thin, flexible and simultaneously elastic film coating. In the “forward” direction (guiding direction (12)), the structured rubber (8) is followed by a triangular sealing wedge (10) made of an elastic material, such as a rubber-based structural foam. The sealing wedge (10) is beveled in the guiding direction (12). In the execution example, the sealing wedge (10) was made of the same structured rubber material as the structured rubber (8). As a result, both components ((8) and (10)) can be glued together using a corresponding specific adhesive. In commercial production, other constructive solutions can also be implemented, such as, e.g., a one-piece execution. Moreover, a triangular sealing lip design tapered in the direction of the corner joint (1) is also conceivable with the same technical effect. The two contact surfaces (11) of this triangular tapered sealing wedge (10) are positioned at a 90° angle to each other. The constructive shape is selected so that the body of the sealing wedge (10) is slightly compressed upon the placement of the application nozzle on the substrate (5) bringing about a sealing effect. To this end, the nozzle has to be guided with slight mechanical, manually applied pressure in the corner joint (1).

In an industrial application, mechanically applied pressure is also conceivable.

Furthermore, the constructive design of the elastic structured rubber (8) was selected so that the outer corners (27) pointing towards the adhesion surfaces (3) are also compressed upon positioning of the application nozzle (5). As a result, the surface (9) of the structured rubber (8) takes on a slightly round shape, which ensures the concave molding of the face (4). Concurrently, the elastically deformed outer corners (27) seal off the application area (15) towards the adhesion surfaces (3) so that sealant (silicone) cannot leak out on the side. In this context, the overall elastic consistency of the structured rubber (8) has proven to be advantageous because all common irregularities (e.g., transverse joints between tiles) are largely compensated and the face (4) attains a consistent and even molding. Minor deviations caused by the usual tolerances in construction regarding the application substrate (29) have an effect on the width of the face (4), however, these are hardly perceivable in the visible appearance because of the smooth transitions in this type of application. As a result, the sealant bead (2) is flexibly adjusted to the application substrate (29). In the execution example, the compression of the outer edges is approx. 5 mm. The necessary pressure caused by this are easy to handle for the user.

In the case of another, e.g., level surface profile (straight hypotenuse according to the definition above), the uncompressed surface (9) of the elastic structured rubber (9) should be selected for a concave shape (with regard to the longitudinal axis); this results in an almost level surface (9) of the structured rubber (8) and a corresponding face (4) in the compressed state.

The sealing wedge (1), which is, however, set back to the level of the hypotenuse for shaping the sealant bead (2), is directly followed by the structured rubber (8), the surface of which points towards the corner joint (1) forms the shaping area (14). At its beginning, directly behind the sealing wedge (10), this has a feed opening (18) and it ends with the smoothing zone (25).

During the application, the sealing material is pressed through the nozzle flange (34) to the nozzle head (7) and into the feed opening (18) between the structured rubber (8) and the adhesion surfaces (3) into the application area (15), i.e., between the adhesion surfaces (3) and the shaping area (14). All the opening cross-sections up to this point are generously dimensioned so that the material is fed to the nozzle head (7) without any significant internal frictional resistances (pipe frictional resistances).

In the nozzle head (7), in the application area (15), the sealant material paste accumulates and can only escape in the direction toward the smoothing zone (25). In terms of their construction, the flow cross-sections within the nozzle body (6) are dimensioned with regard to the free flow cross-section in the application area (15) so that the proportion is a multiple, e.g., quadruple, thereof. This results in a flow pressure resistance behind the feed opening (18). In addition, the sealing material has relatively strong adhesion characteristics. The interior shape between the adhesion surfaces (3) and the smoothing zone (25) and, in particular, the ratio between the interior surface and the free flow cross-section, which has unfavorable flow characteristics, and the length of this area selected for constructive reasons, results in further flow pressure resistance along with an accompanying pressure build-up. If the nozzle head (7) is then moved in the guiding direction (12), while feeding pressure is generated at the same time, the sealant material penetrates into the area between the adhesion surfaces (3) and the smoothing zone (25). Then, it is slowed down by the adhesion to the adhesion surfaces (3), and, in addition, it accumulates as a result of the adhesion to the surface of the smoothing zone (25) because of the relative movement in the guiding direction (12). This is connected with a disproportionately strong pressure increase within the shaping material because the application area (15) is sealed off towards the application substrate (29) by the sealing wedge (10) and the compressed outer edges (27) of the structured rubber (8). This pressure increase is perceived by the user as the “pressure point”. If the user manually presses the sealant material into the application nozzle (5), e.g., with the help of a commercially available applicator gun operated via a hand lever, all of this (adhesion characteristics and ratio between the interior surface and the free flow cross-section which is unfavorable for the flow) leads to a perceptible change in the pressure resistance in the counterpressure of the hand lever.

Using the pressure resistance perceived by the user as a simple manual control parameter has proven advantageous. The user has to build the pressure to this perceptible pressure point and then maintain it at this level. Provided this pressure point is not exceeded as a result of excessive force, a sealant bead (2) with a smooth face (4) forms behind the smoothing zone (25). In this process, the application system largely compensates fluctuations in the guiding speed of the nozzle head (7). The invention comprises a closed application system in which all pressures and compression moldings are possible irrespective of the guiding direction (12) (horizontal, vertical and overhead).

Sealant waste is not generated as there is no discharge of excessive material.

The guiding system of the application nozzle (5) consists of two contact bodies ((16) and (21)).

The first contact body (16) is located at the front end of the nozzle head (7). This contact body (16) carries the structured rubber (8) and the triangular pointed sealing wedge (10). In the execution example, the contact body (16) is glued to the nozzle body (6). For this purpose, the end of the nozzle body (6) has a circumferential receiving notch (26) in this area. In the execution example, the contact body (16) is made of an elastic plastic. In commercial production, thermoplastic welding or a one-piece construction in which the nozzle body (6) and the contact body (16) could be made of the same material are conceivable. The outer surfaces of the contact body (16) which run parallel to the guiding direction (12) are formed as sliding surfaces (17). In this, they form a type of skid on each side and the nozzle head (7) largely glides on these. However, it is material that the guiding and the mechanical sliding of the nozzle head (7) and the sealing function of the outer corners (27) of the structured rubber (8) and of the sealing wedge (10) are separate from each other. Here, the outer corners (27) of the structured rubber (8) and the contact surfaces of the sealing wedge (11) do not concurrently serve as sliding surfaces, as in the case of the above-mentioned device in which the sealing material is expressed in front of a smoother tool. Therefore, the sealing effect of the outer corners (27) of the structured rubber (8) and of the contact surfaces of the sealing wedge (11) are much more efficient in the application nozzle (5) as per the invention.

The sliding surfaces (17) of the first contact body (16) and the sliding surfaces (22) of the further second contact body described (21) are positioned at an angle of 90° to each other. If the nozzle with the contact body (16) is placed in the 90° corner, it will center itself towards the joint. In practice, however, the corners into which the sealant bead (2) is to be placed are often not positioned at exact 90° angles to each other (e.g., 890 corner) due to the usual tolerances in construction. To avoid jamming, the sliding surfaces (17) of the first contact body have a slightly convex curve along the longitudinal axis. As a result, both the surface having effective contact and the frictional resistance which arises during jamming is reduced. Moreover, the material used for the contact body (16) and the second contact body (21) described below as well as the constructive shaping are relatively elastic.

Both of these compensate any potential jamming. As a result, the nozzle head (7) is guided parallel to the corner joint (1) but jamming due to a deviation in the angle (e.g., in the case of an 89° corner) is avoided.

The front edge (20) of the contact body (16) which is positioned in the guiding direction (11) has a broad bevel (19). It consists of three individual surfaces and, as a result, prevents the front edge (20) from getting caught during guiding of the device. As in the case of skids, this permits uniform sliding and guiding of the application nozzle (5).

For further stabilization in guiding, a second, U-shaped contact body (21) is designed. This is inserted into a groove (30) located on the outside of the nozzle body (6) at a short distance from the first contact body on the front part of the nozzle (nozzle head (7)). The second contact body (21) can be slightly thinner in its design. The outer edges of the second contact body (21) also serve as sliding surfaces (22).

The lengths of the sliding surfaces (17) and (22) of the first (16) and second (21) contact body are selected so that they ensure sufficient stabilization for even sliding and can be guided over any unevennesses commonly encountered, such as transverse tile joints. At the same time, the nozzle head is simple and easy to guide at a constant speed because friction resistances are easy to assess. Specifically, the friction coefficients of the sliding surfaces (17) and (22) of both contact bodies ((16) and (21)) are selected so that the adhesion resistance and the sliding resistance are relatively close. Technically, this can be achieved through a corresponding coating and the surface shape (outside curvature in the direction of the longitudinal axis) if required.

Moreover, several small contact bodies technically having overall sliding characteristics similar to the two contact bodies described herein ((16) and (21)).

The same characteristics as in the description of the front edge (20) of the first contact body (16) also apply to the material selection and the shaping of the front edge of the second contact body (21). However, the front edge of the second contact body (21) has a notch (24).

This enables the user to inspect the development of the joint better visually.

An elastic locking bolt (31) is designed between the two contact bodies ((16) and (21)) as a temporary fixation of the second contact body (21). This is firmly mounted to the bottom of the first contact body (16) and clamps to a fixing surface (32) on the second contact body (21). If the locking bolt (31) is pushed towards the first contact body (16), the second contact body (21) is unlocked, and can then be removed or extracted from its guide in the groove (30) within the nozzle body (6). In addition, one of the rear edges of the second contact body (21) is equipped with a shaping edge (33). The shape of this shaping edge (33) corresponds to the surface profile of the sealant bead (2). This means this contact body (21) also has the function of a joint smoother. As a result, the user can separately shape the central sealant bead joint which cannot otherwise be created using the application nozzle (5). In as far as the other edges of the contact body (21) are tapered with a bevel, they can be used as scrapers. If necessary, the user can use this to take up any excess sealant materials from the application substrate (29). After the separate use of the contact body (21), it can be reinserted into the groove (30) in the nozzle body (6) and is then held by the locking bolt (31).

As another characteristic of this design, the area in front of the nozzle head (7) is designed as a spring bearing (23) which absorbs any jamming in guiding the nozzle. For example, four accordion folds can be included in the design. The according design of the construction also helps to compensate slide deviations in an axial direction.

If you place the application nozzle as per the invention (5) in the 90° corner into which the sealant bead (2) is to be installed with slight pressure, the nozzle head (7) aligns itself relatively independently. This is achieved by the spring bearing (23) and the constructional shape of the two contact bodies ((16) and (21)). The shaping area (14) positions itself so that it forms the hypotenuse in the cross-section triangle of the sealant bead (2) in the corner joint (1).

In the execution example, the nozzle body (6) has a straight design; however, in view of the spring bearing, bending of the nozzle flange (34) has proven sensible. The execution example provides for a bending angle of 20° in the nozzle flange (34).

This produces an offset facilitating the application from room corners. With regard to other application constellations, nozzle flange shapes, e.g., diagonal with regard to the shaping area (14) or designs without the offset, are also conceivable.

In contrast to the conical tapered application nozzle described above in the first part, the selected width of the face (4) cannot be changed once the selection has been made in the application nozzle (5) as per the invention due to its design. Based on practical experience, the sealant bead (2) in the corner joint (1) is produced with a face (4) of approx. 8 mm in width. Therefore, this width, which can be referred to as a commonly used width, was selected as for the calculation for the execution example with the sliding areas (17) and (22) being exactly positioned in a 90° corner. Irrespective of this, application nozzles as per the invention can also be produced for other sealant bead widths and can be selected by stocking up on these.

In conclusion, the application nozzle (5) as per the invention can be guided easily and evenly. As changes in the pressure resistance can be easily detected by the user, this provides a simple control parameter for the user resulting in a flawless face (4) without any lateral smears in one simple and easy-to-master work process. The sealant material can be applied almost entirely without any losses both vertically and horizontally as well as overhead. Due to the dual function of the second contact body (21) as a simultaneous joint smoother, a central sealant bead joint can be produced.

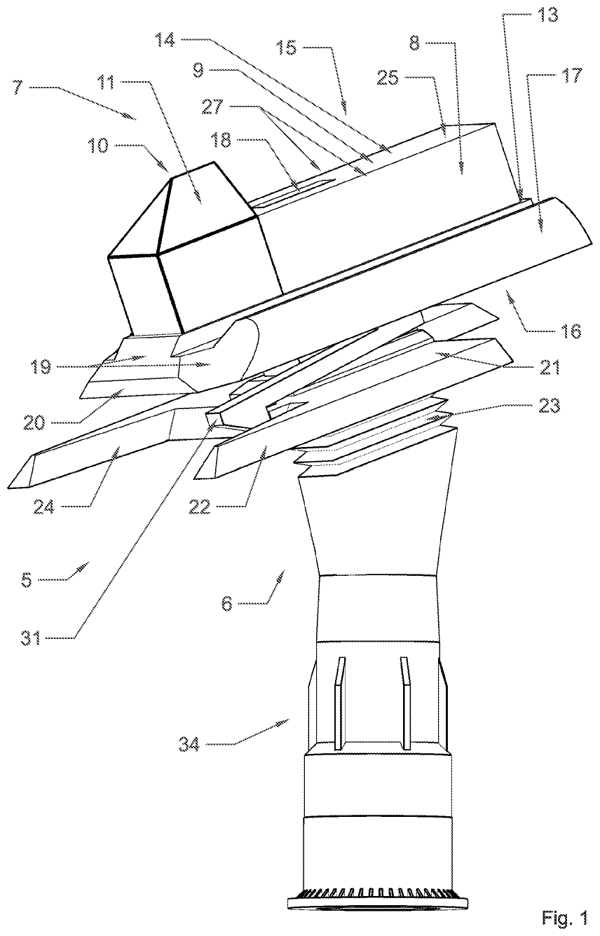

FIG. 1 shows the application nozzle as per the invention (5) with corresponding references in a lateral full view.

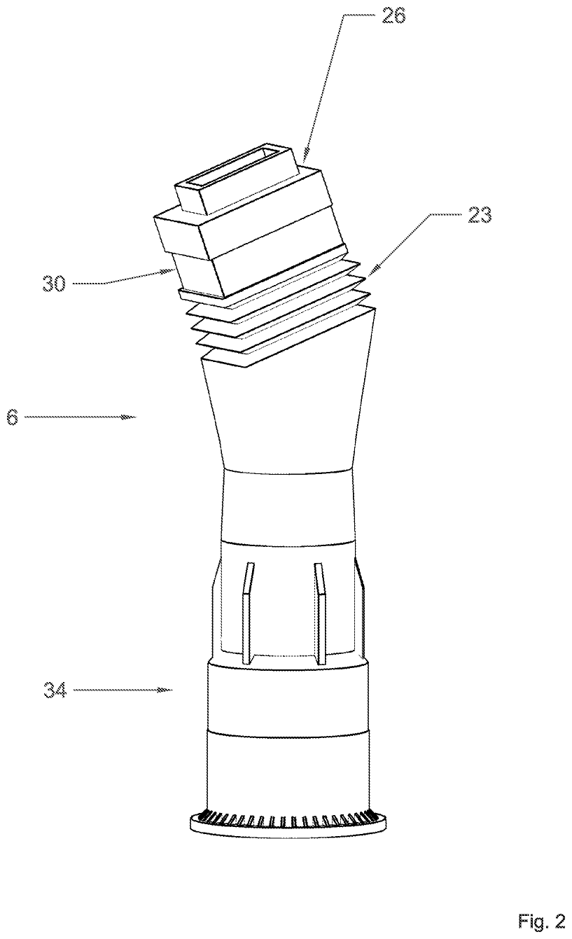

FIG. 2 shows the nozzle body (6) of the application nozzle as per the invention (5) with references and without the contact bodies (16) and (21).

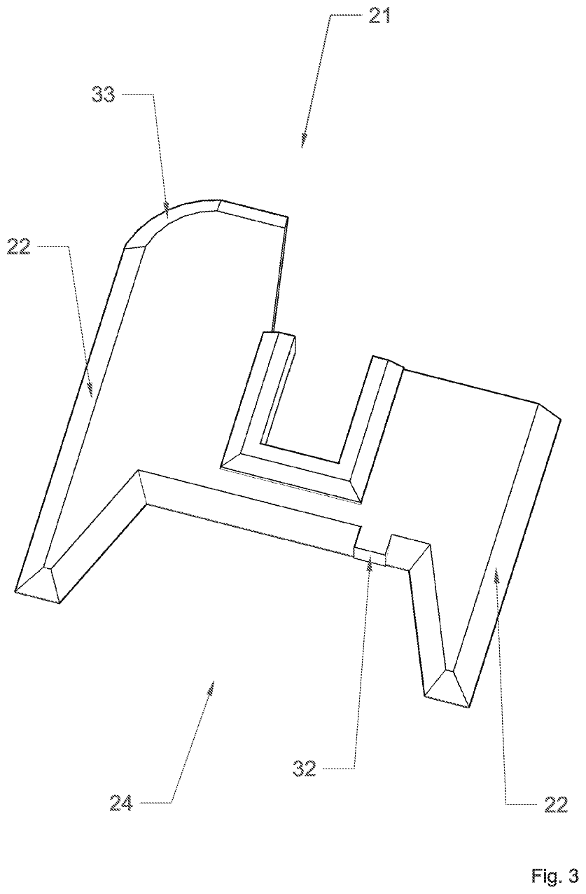

FIG. 3 shows the second contact body (21) with references.

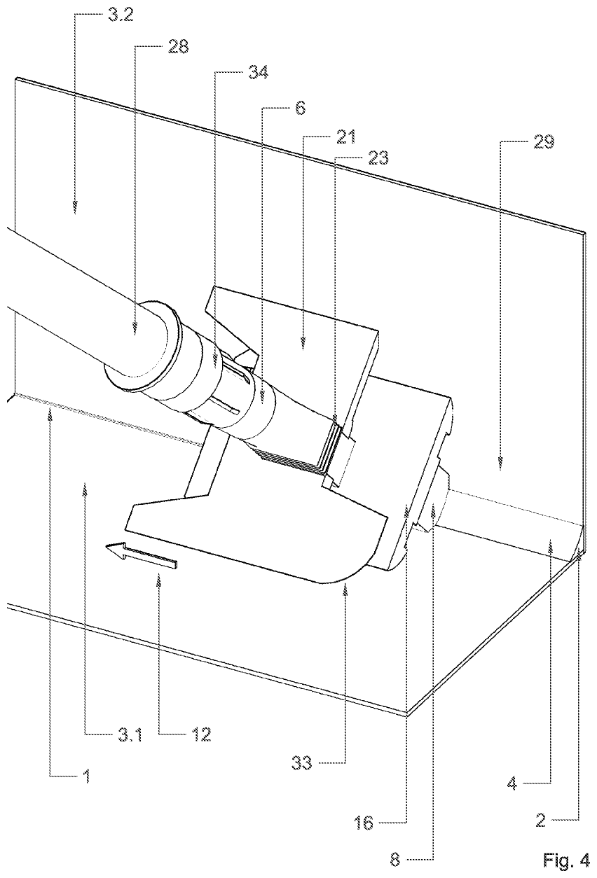

FIG. 4 shows the application nozzle according to the invention (5) with references during the application of sealant in a corner joint (1).

### REFERENCE LIST

(1) Corner joint
(2) Sealant bead
(3) Adhesion surfaces
(4) Face
(5) Application nozzle as per the invention
(6) Nozzle body
(7) Nozzle head
(8) Structured rubber
(9) Surface of the structured rubber
(10) Triangular sealing wedge
(11) Contact surfaces of the triangular sealing wedge
(12) Guiding direction
(13) Mounting for the structured rubber
(14) Shaping area
(15) Application area
(16) First contact body
(17) Sliding areas of the first contact body
(18) Feed opening
(19) Bevel on the first contact body (16)
(20) Front edge of the first contact body
(21) Second contact body
(22) Sliding surfaces of the second contact body
(23) Spring bearing
(24) Notch in the second contact body
(25) Smoothing zone
(26) Receiving fold
(27) Outer edges of the structured rubber pointing to adhesion surfaces
(28) Sealant supply
(29) Application substrate
(30) Groove in nozzle body
(31) Elastic locking bolt
(32) Clamping area on the second contact body
(33) Shaping edge as a joint smoother
(34) Nozzle flange

1-9. (canceled)

10. An application nozzle for manual application of a dimensioned sealant bead in a guiding direction, the dimensioned sealant bead having a paste consistency for sealing corner joints between a first adhesion surface and a second adhesion surface, comprising:
a nozzle head having a shaping area; and
a triangular sealing wedge made of elastic material,
wherein the nozzle head is made of an elastic structured rubber in the shaping area,
wherein the triangular sealing wedge is configured to tightly seal an application area is formed between the first adhesion surface and the second adhesion surface.

11. The application nozzle according to claim 10 wherein the elastic structured rubber of the nozzle head is designed for the first adhesion surface and the second adhesion surface to be compressed upon placement of the application nozzle on an application substrate and for creating of a flexible lateral seal as a constructive shape of the elastic structured rubber.

12. The application nozzle according to claim 10, further comprising a feed opening in an area directly behind the triangular sealing wedge, wherein the feed opening leads directly through the structured rubber.

13. The application nozzle according to claim 10, further comprising a positioning guide system for positioning the shaping area of the nozzle head, wherein the positioning guide system comprises a first contact body and a second contact body.

14. The application nozzle according to claim 10, further comprising a nozzle body wherein a fluid mechanics design of the nozzle body in relation to a fluid mechanics design of the application area is configured to create a pressure point as a manually usable control parameter.

15. The application nozzle according to claim 10 wherein the elastic structured rubber is designed for adapting to the first adhesion surface and the second adhesion surface by sealing the application area laterally and in the guiding direction.

16. The application nozzle according to claim 10, wherein a surface of the elastic structured rubber is smooth for forming a visible surface of the dimensioned sealant bead.

17. The application nozzle according to claim 10, wherein the triangular sealing wedge is designed as a triangular sealing lip.

18. The application nozzle according to claim 10, wherein the elastic structured rubber is formed to have edges which are compressed when the application nozzle is placed on the first adhesion surfaces and the second adhesion surface.

19. The application nozzle according to claim 12, wherein a cross-section of a duct for the sealant leading to the feed opening is larger than a cross-section of the application area.
